(19) United States
(12) Patent Application Publication
(10) Pub. No.: US 2011/0094387 A1
(43) Pub. Date: Apr. 28, 2011

(54) REDUCTION OF THE COOLING TIME OF THE BEER IN PROCESSING TANKS BY INJECTING CARBON DIOXIDE GAS

(76) Inventors: Angel José Enrique SOTO PORRUA, Colonia Santo Tomas (MX); José Lauro Garcia Salinas, Colonia Santo Tomas (MX)

(21) Appl. No.: 12/882,467

(22) Filed: Sep. 15, 2010

(30) Foreign Application Priority Data
Oct. 22, 2009 (MX) MX/A/2009/011435

(51) Int. Cl. C12C 11/11

(52) U.S. Cl. 99/276; 62/307; 165/96

(57) ABSTRACT

A method and apparatus for cooling liquids, specifically beer, is disclosed. The method and apparatus utilize fluid carbon dioxide injected into a cooling apparatus. The cooling apparatus is submerged vertically in the beer when it is contained in a tank with the aim of cooling it.

### CROSS-REFERENCE TO RELATED APPLICATIONS

Not applicable.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION-BY-REFERENCE OF MATERIALS SUBMITTED ON A COMPACT DISC

Not applicable.

### BACKGROUND OF THE INVENTION

1. Field of the Invention

Presented here is a procedure that helps reduce the time employed in the cooling of liquids, and in particular beer, in the closed processing tanks containing it, using gases that are expanding and in close contact with the liquids to be cooled.

2. Description of Related Art Including Information Disclosed Under 37 CFR 1.97 and 37 CFR 1.98.

Currently there are various methods used for the cooling of the beer. The one most used is that of cooling by means of jackets fitted to the exterior walls of the tanks. The heat transference is carried out through the wall of the tank with that of the jacket. This method presents the inconvenience of limiting the heat transference because the dimensions of the tank are fixed, meaning that increased cooling needs are unable to be satisfied were this necessary. This lengthens the cooling times. Additionally the turbulence of the beer inside the tank is low and therefore the heat transference is also low.

Another recent method is the use of submerged jacketed coolers with the characteristic of being built out of a tube that has a jacket fitted around its entirety and length in which a coolant circulates through the intermediate space that exists between the tube and the jacket.

This method reduces cooling time compared with the previous one and it means that more than one set of these can be installed depending on requirements.

In both cases the heat transference coefficient is low, although it is higher in that of the cooling apparatus submerged into the beer.

Typically, once the fermentation of the beer in the closed tanks has concluded, the process of its cooling begins. The time employed is long due to the large volumes stored in the tanks in which the fermentation was carried out. The tanks' geometry is generally vertical. They have dimensions of height and diameter that limit the area of heat transference of the coolant circulating through the external walls of the tank through fitted circulation jackets. This area cannot be increased further as it is fixed; limited by the tank's dimensions. The coolant's temperature also cannot be much reduced because of the risk of freezing the beer that is in contact with the internal walls through which the coolant circulates.

The above-described method entails the generation of low turbulence in the beer contained in the tank, wherein beer moves slowly and almost exclusively due to the variations in its density as its temperature falls. The transference of heat between the coolant and the beer through the wall of the tank is low, meaning that long times are needed to effectuate the cooling.

Another method used to reduce the time used in cooling the beer in the closed tanks is that of increasing the speed of the beer and therefore its turbulence inside the closed tank. The objective of this is to increase the transference of heat between the beer and the coolant, leading to a shorter cooling time. A cooling apparatus is used for this, which is described below.

The cooling apparatus is a heat exchanger built out of a tube that has a jacket fitted around its entirety and length. There is an intermediate space between the tube and the jacket through which a coolant circulates.

The wall of the tube has two faces, the interior and the exterior. In turn, the jacket has two faces, an interior one and another exterior one.

When the cooling apparatus is submerged into the beer vertically, i.e. leaving one end above and the other below, the exterior face of the wall of the jacket is in total contact with the beer. The same happens with the tube when it is submerged into the beer. The interior space is flooded, leaving the interior face of the wall of the latter in contact with the beer. The ends of the tube are free, allowing the interior space of the tube to be flooded with the beer.

The heat transference from the beer to the coolant of the cooling apparatus is carried out simultaneously from the beer through the wall of the jacket and from the beer through the wall of the tube.

The lowering of the temperature of the beer inside the tube causes its density to increase and this causes it to move to the bottom, allowing the beer with a higher temperature to enter at the top to be cooled. Therefore, constant circulation will be formed while the cooling process is being carried out.

More than one cooling apparatus can be used depending on the cooling requirements.

The two methods described involve long times needed to achieve the desired cooling of the beer because the convection currents are weak when created only by the density changes of the beer as the temperature drops.

With the aim of drastically reducing the time employed in the cooling of the beer when using the cooling apparatus, the innovation described below is presented.

### BRIEF SUMMARY OF THE INVENTION

The innovation involves the cooling apparatus being installed vertically submerged in the beer inside a closed tank. At the lower end of the tube a pipe is introduced that discharges the CO₂ gas, injecting it into the beer. When the CO₂ comes into contact with the beer, it forms a mixture with the characteristic of having a lower density than that which the beer alone possesses. The low density of the mixture formed causes this to tend to go to the surface. As the injection of the CO₂ is done by the lower intake of the inside of the tube, as the mixture rises it will travel the whole inside of the tube to its end. During the ascent, the hydrostatic pressure exerted on the mixture drops making the CO₂ expand and therefore the density of the mixture decreases more and more. This induces the increase of the speed of the mixture, increasing its turbulence also. This process causes high suction on the lower intake of the interior of the tube, which makes the flow of the beer on the lower intake of the interior of the tube increase. The flow of the beer will be dependent on the flow of CO₂ injected. The greater the flow, the greater the speed, and the greater the speed, the greater the turbulence, and therefore the increase of heat transference between the beer and the coolant through the wall separating them.

With this situation a large Reynolds Number is obtained and therefore the heat transference coefficient is high, meaning that the time employed to cool the beer is drastically reduced when compared with other cooling methods. When the CO₂ reaches the surface of the beer, it occupies the free top space inside the closed tank. The CO₂ is extracted through piping towards the suction of a compressor to be compressed and returned to the tank to be fed to the lower end of the inside of the tube of the cooling apparatus and to thus continue with the procedure, thereby forming a cycle until the desired temperature is obtained in the beer contained in the closed tank.

CO₂, the chemical formula of carbon dioxide, is the desired gas to be used because of its nature, having been formed during the fermentation and therefore it does not modify its properties.

The CO₂, during the fermentation, can be collected and conducted through piping to be compressed and stored in a tank or tanks in order to subsequently feed it to the cooling apparatus.

It should be clarified that new CO₂ can be used, thereby avoiding compression. This is not recommendable from an economical standpoint, since a great amount of it would be needed. It is more economical to recycle it.

The quantity of CO₂ needed to be stored if done in this way will be the volume that is used within the cooling apparatus, necessary to fill the free volume within the closed tank, which is used in the conduction piping to the compressor, as well as the return pipe to the tank, plus an extra one. Following this procedure, the quantity of CO₂ used is small and recoverable; there are no losses of CO₂.

To the best of the authors' knowledge, this invention can be summarized as follows.

It is the purpose of the following invention to reduce the times employed in the cooling of beer once it has fermented inside the closed tanks containing it, using for such purpose the injection of CO₂ gas into a cooling apparatus vertically submerged in the beer inside a closed tank to induce turbulence in it and therefore increase the transference of heat between the beer and the coolant circulating through the cooling apparatus.

Another intention of this invention is for the CO₂ gas to be injected through the lower end of the cooler vertically submerged in the beer containing the characteristic of being built out of a tube that has a jacket fitted around its entirety and length and there is an intermediate space between the tube and the jacket through which a coolant circulates.

Another intention of this invention is that when the cooling apparatus is submerged into the beer vertically, i.e. with one end above and the other below, the exterior face of the wall of the jacket is in total contact with the beer and the same occurs with the inside of the inside of the tube when submerged in the beer, leaving the whole interior face of the wall in contact with the beer. The upper and lower ends of the tube are free to allow the interior space of the tube to be flooded with the beer. Another intention of this invention is for the heat transference from the beer to the coolant in the cooling apparatus to be carried out simultaneously from the beer through the wall of the jacket and from the beer through the wall of the tube.

Another intention of the following invention is for the CO₂ gas injected to ascend through the interior of the tube of the cooling apparatus, carrying the beer to its upper end.

Another aim of this invention is that, during the ascent of the CO₂ gas together with the beer through the interior of the tube of the cooler, the exchange of heat between the beer and the coolant will occur through the wall of the tube separating them when the coolant circulates through the intermediate space that exists between the tube and the jacket.

Another intention of the following invention is for the CO₂ by itself to aid the cooling of the beer when the temperature it possesses is lower than that of the beer when it comes into contact therewith.

Another intention of this invention is to cause, if so desired, a powerful turbulence of the must, preventing the yeast from settling on the bottom of the tank during its transformation into beer, helping to further promote the contact between the sugars of the must and the yeast, as well as being able to control the temperature during fermentation.

Presented here is a procedure that helps reduce the time employed in the cooling of beer and inside the processing tanks containing it, using CO₂ gas and in close contact with the beer to be cooled.

Use of the gas carbon dioxide, CO₂ by its chemical formula, or any other gas, that does not alter the characteristics of the beer when the CO₂ is fed by injecting it through the lower intake of the tube that forms part of the cooling apparatus submerged into the beer. As it ascends, the gas travels throughout the interior of the tube of the cooling apparatus until it reaches the surface. The cooler must be submerged into the beer contained in the closed tank.

The cooling apparatus is a heat exchanger built with a tube that has a jacket fitted around its entirety and length. There is an intermediate space between the tube and the jacket through which a coolant circulates.

For the specific case of the cooling of beer, it is desirable to use CO₂ as the gas since it was generated in the beer itself and therefore does not alter the beer's properties.

When the CO₂ comes into contact with the beer, it forms a mixture. This will have a lower density than that which the beer alone possesses, causing it to rise to the surface. This is because both are flowing inside the tube of the submerged cooling apparatus. There is thus an increase in turbulence and therefore the transference of heat from the beer to the coolant, causing its temperature to lower. During the ascent, the CO₂ will in turn be cooling the beer because it is in close contact with the beer as it possesses a low temperature and is subject to turbulence.

With greater turbulence, i.e., a higher Reynolds Number, the heat transference coefficient increases, causing the time employed to cool the beer to be drastically reduced in relation to other cooling methods.

The CO₂ is recovered upon its exit from the tank and is compressed in order to be injected again through the lower intake of the tube of the cooling apparatus submerged in the beer until the desired temperature is obtained.

Due to the shortening of the time employed in the cooling, the tank will be ready before receiving the new charge of the must, thereby reducing the duration of the cycle necessary for the entire process in the production of beer.

Another characteristic of the procedure is also that of being used during the fermentation of the beer to control its temperature.

Another characteristic of the procedure is that of preventing the solid particles suspended in the beer itself from settling due to the strong suction formed at the lower intake due to the tube of the submerged cooling apparatus. The lower intake is located close to the bottom of the tank. The particles are suctioned, facilitating their mixture with the rest of the beer contained in the tank. The result is that the particles will be disseminated throughout the liquid instead of being partially settled at the bottom.

Another characteristic of the use of the CO₂ in the manner described is that of being able to increase the cooling capacity as it has the property of being compatible with any other de system cooling already installed in the tanks.

### BRIEF DESCRIPTION OF THE SEVERAL VIEWS OF THE DRAWINGS

FIG. 1 shows the vertical section of a standard closed tank in which can be seen the intake of CO₂, its passage through the interior of the tube of the submerged vertical cooling apparatus, where the heat transference takes place as well as the exit of the CO₂ from the closed tank.

FIG. 1 also shows the passage of CO₂ outside the tank with the aim of compressing it and storing it or otherwise, before it is returned to the interior of the tank.

FIG. 2 shows the tank and the cooling apparatus in plan view.

### DETAILED DESCRIPTION OF THE INVENTION

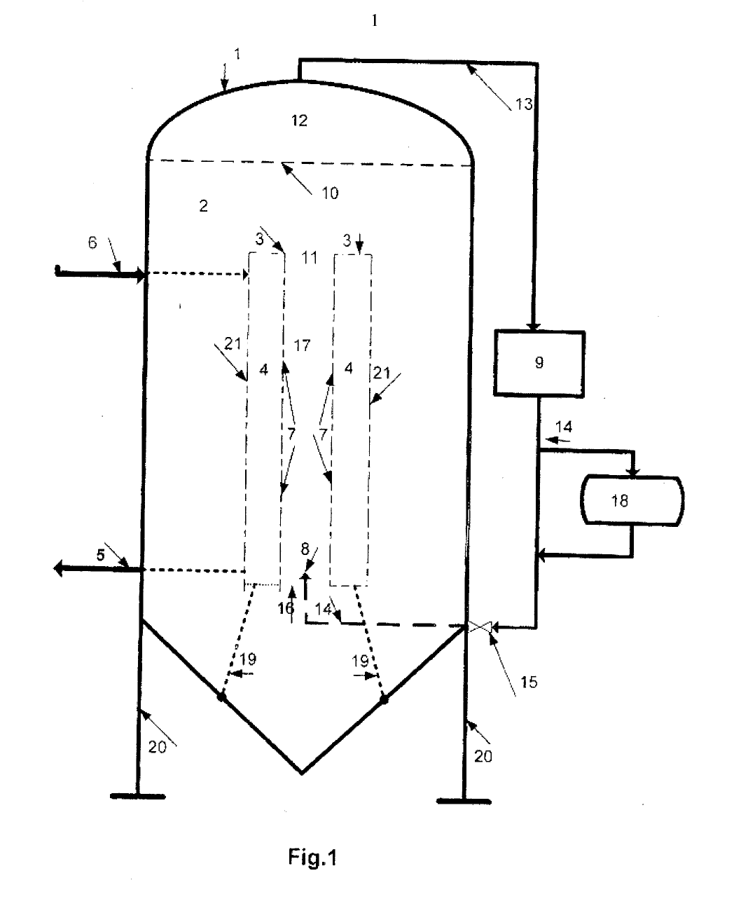

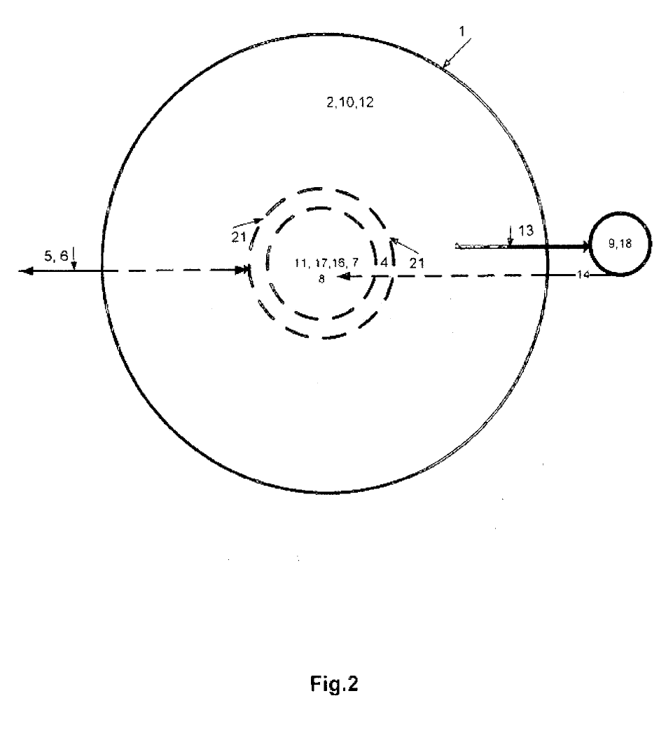

With reference to FIGS. 1 and 2 and following the same nomenclature of the indicated reference signs, this invention is such that a tank 1 containing a volume of beer 2 in which is submerged a cooling apparatus 3 wherein a coolant is circulating through the intermediate space 4 formed by the jacket of the cooling apparatus submerged 3 in the beer 2. The coolant is supplied by the piping 6 and is extracted through the piping 5 after traveling through the entire free space of the intermediate space 4 existing in the submerged cooling apparatus 3. The CO₂ is being injected through intake of the lower base 16 of the interior of the tube of the submerged cooling apparatus 3, through the nozzle 8 under pressure with the aid of the compressor 9. This CO₂ in contact with the beer upon entering through the base of the cooler 16, when it exits through the nozzle 8, causes the beer to be sucked into the intake of the lower base 16 of the inside of the tube of the submerged cooling apparatus making it rise mixed with the CO₂ through the interior part of the tube 17 to the end 11 of the cooler of the submerged cooling apparatus 3 and continue up to the surface of the beer 10 contained in the tank 1. The ascent of the CO₂ from 8 to 11 with the beer causes turbulence due to the increase in speed it acquires because the CO₂ is expanding as the hydrostatic pressure is decreasing, and also the density of the mixture of CO₂ with the beer drops. The turbulence allows the heat transference coefficient to increase in the interior wall 7 of the tube in contact with the beer that rises together with the CO₂ from 16 to 11 through the interior of the tube of the submerged cooling apparatus 3. This mechanism is carried out from point 16 to 11, which is the exit of the beer and of the CO₂, which will constantly occupy the free space 12 of the tank to be continuously extracted through the pipe 13 connected to the suction of the compressor 9. After compressing the CO₂ through the compressor 9 it is transferred through the pipe 14 to the lower intake 16 of the interior of the tube of the submerged cooling apparatus 3, having first passed through the pressure regulator valve 15 and so on successively until all of the beer in the tank reaches the desired final low temperature. Simultaneously, if so desired, after the compressor 9, the CO₂ can be stored in the tank 18 for later use incorporating it into the pipe 14.

At the same time through the exterior wall of the jacket 21 of the cooling apparatus 3 in contact with the beer, heat transference is also carried out between the beer 2 and the coolant 4, although here the action of the CO₂ is not involved.

The submerged vertical cooling apparatus 3, is fixed internally to the tank 1 by means of supports 19. The tank is fixed to the floor by the exterior supports 20. The quantity of fixations will depend on the needs of each tank.

Preferred embodiment of the invention.

The CO₂ stored in the tank 18 or directly from the compressor 9 is transferred through the pipe 14 passing through the pressure regulator valve 15 until it is released through the nozzle 8 to the lower intake 16 of the interior of the tube of the submerged cooling apparatus 3 into the beer 2. The CO₂, together with the beer, rises from point 16 to 11 turbulently. The heat is transferred from the beer to the coolant circulating through the intermediate space 4 of the cooling apparatus 3. When the CO₂ and the beer reach the surface 10, the CO₂ will occupy the space not occupied by the beer in the dome of the closed tank 12, to be extracted by means of the pipe 13 that is connected to the suction of a compressor 9, and then compressed for return through the pipe 14 to the lower intake 16 of the interior of the tube of the submerged cooling apparatus 3 through the nozzle 8. The cooling continues thus successively until the desired temperature of the beer in the tank is achieved.

It is desired that the coolant circulating through the intermediate space 4 of the submerged cooling apparatus 3, when it is liquid, shall circulate from top to bottom, i.e. the coolant is being received by the pipe 6 and moved along through the pipe 5, since the CO₂ and the beer will circulate from bottom to top from 16 to 11. In this way the countercurrent flow is obtained, which is as desired, since the heat transference is greater than when this done in parallel. When the coolant is a liquid that evaporates during the heat exchange it is the same whether it is in parallel or against the current.

Having described the invention, what is described in the invention is considered a novelty and therefore the contents of the following statements are claimed as our property.

1. The injection of the gaseous fluid carbon dioxide, or rather CO₂ by its chemical formula, through the lower intake of the interior of the tube of a cooling apparatus submerged vertically in the beer when it is contained in a tank with the aim of cooling it.
The cooling apparatus is a heat exchanger built with a tube that has a jacket fitted around its entirety and length. There is an intermediate space between the tube and the jacket through which a coolant circulates.
When the CO₂ gas is injected through the lower intake of the interior of the tube of a cooling apparatus submerged vertically in the beer it leads to the formation of a mixture with less density than that of the beer alone, making the mixture rise through the interior of the tube to its upper end.
The coolant which in turn travels throughout the intermediate space that exists between the tube and the jacket, where the transference of heat ceded by the beer to the coolant takes place. The injection of the CO₂ must be extended until the desired temperature of the beer is obtained on cooling.
What is claimed as our property is that of the use of CO₂ gas in the conditions described.

2. It is therefore, by extension, the injection of any other gaseous fluid in any other liquid for cooling under the conditions described in claim 1.

3. The injection of the gaseous fluid carbon dioxide, or rather CO₂ by its chemical formula, claimed in accordance with claim 1, also characterized by the fact that it may also be used as a means for preventing the yeast from settling at the bottom of the tank during the process of fermentation of the beer inside the tanks in which it is carried out; this is due to the suction caused by the beer when the beer is carried by the gas at the lower intake through the interior of the tube of the submerged cooling apparatus. The closer the suction is to the bottom, the greater will be the suction of the sediments from the bottom of the tank.

4. The injection of the gaseous fluid carbon dioxide, or rather CO₂ by its chemical formula, claimed in accordance with claim 1, also characterized by the fact that it may also be used as a means of controlling the temperature of fermentation of the beer inside the tanks in which it is carried out, when the submerged cooling apparatus is used.
